(19) United States
(12) Patent Application Publication
(10) Pub. No.: US 2024/0150205 A1
(43) Pub. Date: May 9, 2024

(54) APPARATUS FOR ELECTROCHEMICAL REGENERATIVE TREATMENT OF WATER AND METHODS OF USE

(71) Applicant: VIRIDIS RESEARCH INC., Vancouver (CA)

(72) Inventor: Macarena A. CATALDO-HERNANDEZ, Vancouver (CA)

(21) Appl. No.: 18/550,242

(22) PCT Filed: Mar. 14, 2022
(86) PCT No.: PCT/CA2022/050375

§ 371 Date: Sep. 12, 2023

Related U.S. Application Data
(60) Provisional application No. 63/161,271, filed on Mar. 15, 2021.
(60) Provisional application No. 63/161,278, filed on Mar. 15, 2021.

(51) Int. Cl. C02F 1/467; C02F 1/461; C02F 101/30; C02F 103/00

(52) U.S. Cl. CPC C02F 1/4672; C02F 1/46109; C02F 2001/46133; C02F 2001/46157; C02F 2101/30; C02F 2103/002; C02F 2201/4611; C02F 2301/022; C02F 2303/24

(57) ABSTRACT

Apparatus and methods are provided for the targeted removal and degradation of at least one contaminant from a fluid stream with at least one physical retention unit containing a retention material configured to receive and capture the at least one contaminant from the fluid stream, and at least one electrochemical cell having a first and a second electrode, operatively connected to the physical retention unit, wherein at least one oxidizing agent(s) generated by electro-oxidative reactions of the at least one electrochemical cell are supplied to the physical retention unit to contact and degrade the at least one contaminants retained and captured within the retention material.

### CROSS-REFERENCE TO RELATED APPLICATIONS

The present application is a U.S. National Phase entry under 35 U.S.C. § 371 of PCT/CA2022/050375 filed on Mar. 14, 2022 entitled “APPARATUS FOR ELECTROCHEMICAL REGENERATIVE TREATMENT OF WATER AND METHODS OF USE,” which claims benefit of priority to U.S. Provisional Patent Application Nos. 63/161,271 and 63/161,278 both filed Mar. 15, 2021, which are specifically incorporated by reference herein for all that they disclose or teach.

### FIELD

Embodiments herein are generally related to improved systems and methods for the treatment of fluids, such as water, wastewater, and greywater. Specifically, embodiments are generally related to systems and methods of coupling the filtration of contaminants with electrochemical oxidation processes for enhanced removal and degradation of the filtered contaminants from the fluids.

### BACKGROUND

The pervasiveness of organic compound pollutants such as pesticides, dyes, pharmaceutical compounds, microplastics (MPs), and biofilms in water ecosystems continue to increase, particularly as plastic production surges. Evidence suggests that almost seventy-one percent (71%) of plastic waste is already directly absorbed by the environment, and that almost 8 million metric tons of plastic waste mixes with the marine ecosystem each year, a number that is projected to rise fourfold by 2050.

Greywater and wastewater are major carriers of microplastics (e.g., microbeads, microfibers) which represent more than sixty percent (60%) of the total microplastics pollution on earth, however neither ship-based greywater treatment systems nor most land-based wastewater treatment plants (WWTPs) can successfully remove pollutants from effluent.

There is a clear need for improved systems and methods for effectively removing organic pollutants from water, including wastewater and/or greywater.

Various attempts have been made to eliminate organic compound pollutants from wastewater. Some attempts have focused on physical separation of the pollutants from the wastewater, such as through adsorption and membrane separation techniques, while other attempts have focused on oxidative degradation of the pollutants, such as through advanced oxidation techniques.

More specifically, some membrane separation techniques can provide the selective entrapment of organic compounds from wastewater using physical retention methods including settling treatments, biofilters, bioreactors, and/or biologically active filters. For example, some membrane separation techniques comprise physical filtration methods characterized by their ability to separate compounds of different sizes and characteristics.

Known membrane separation techniques, however, can have limited efficiencies and are highly dependent upon the size, shape, charge, and/or type of compound, as well as whether the techniques are used alone or in combination with other treatments. Known membrane separation techniques also often require the membrane to have active role in separate the compounds (e.g., the membrane itself serves to chemically bind with the compounds), resulting in compounds only being retained within the membrane for a short time and decreasing the overall lifespan of the membrane (e.g., membrane covered with catalyst has a shorter lifetime). Known membrane separation techniques can also suffer from surface fouling, causing the problems of membrane permeation flux and retention drop, and requiring efficient, stable cleaning procedures. Moreover, known membrane separation techniques also typically only serve to capture the pollutants from the wastewater, necessitating additional processing treatments to degrade the captured fragments.

Oxidative degradation techniques, such as electrochemical oxidation, can provide rapid and non-selective oxidation of organic compounds in wastewater. Within the field of electrochemical treatment of wastewater, there are two primary approaches to the oxidization of contaminants, namely, the direct electrochemical oxidation of compounds directly on the anode surface, and the indirect electrochemical oxidation of compounds through the in-situ generation of chemically oxidizing species (such as hydroxyl, chlorine, oxygen, or perchlorate radicals, or compounds such as hypochlorite, ozone, or hydrogen peroxide). These chemically oxidizing species are generated directly on the anode surface and subsequently oxidize contaminants in bulk solution (i.e., within the wastewater).

A variety of electrochemical cell configurations that include flow-through parallel plates, divided chambers, packed bed electrodes, stacked discs, concentric cylinders, moving bed electrodes and filter-press have been developed for both direct and indirect electrochemical treatment of fluids. However, common to all of these electrochemical cell configurations is poor operational efficiency and performance leading to high energy consumption and/or low contaminant removal rates. Moreover, such electrochemical cell configurations can also suffer from a relatively short lifetime of the electrodes and the increased costs associated with needing to replace the consumed electrodes, particularly where sacrificial anodes are used.

For example, due to the very low ionic conductivity of wastewater, known systems that use wastewater as the electrolyte require the addition of significant concentrations of supporting chemical electrolytes to improve cell efficiency and obtain reasonable cell voltages. This requirement can lead to the need for added anolytes and/or catholytes with base concentrations and pHs that are non-compliant with contaminant and pH discharge limits, adding cost to the treatment for both the disposal of the treated wastewater and handling of the added electrolytes. Large electrode gaps and low surface area electrodes can also contribute to efficiency loses and low contaminant removal rates. For example, slow mass transport in the pores of porous beds and non-optimized catalyst materials with poor reaction kinetics requiring high electrode overpotentials also contribute to lower performance efficiency and losses. Such operating conditions can lead to the need for large, complex reactors. Known oxidative electrochemical systems can also require large amounts of additionally added chemicals and/or feed oxygen and provide secondary pollution that creates additional costs and are often hazardous to the environment.

Many attempts have been made to increase the performance of electrochemical cells for wastewater treatment. However, to date, there remains a need for an improved apparatus and methods of use for removing pollutants from wastewater, such apparatus operative to combine the physical retention of organic compounds with the production of oxidizing radicals to degrade the retained compounds. It is desirable that such an improved apparatus enhance fast mass transport (turbulent flow) by coupling the physical capture and oxidization of organic compounds for efficient and effective degradation of pollutants regardless of their size, shape, charge, and/or type. It is also desirable that such an improved apparatus provide a dual-functioning system operative to rapidly and non-selectively degrade organic compounds within a fluid stream without generating secondary contaminants and while maintaining pH, to provide an environmentally friendly, green alternative to existing technologies.

### SUMMARY

According to embodiments, apparatus and methods for removal and degradation of at least one contaminant from a fluid stream are provided. In some embodiments, the apparatus comprises at least one physical retention unit, the unit having at least one inlet for receiving at least a portion of the fluid stream as an input fluid stream and at least one outlet for discharging at least a portion of the fluid stream as an output fluid stream, and containing a retention material, the material configured to receive and capture the at least one contaminant from the input fluid stream, and at least one electrochemical cell, the cell having a first and a second electrode, operatively connected to the physical retention unit, wherein at least one oxidizing agent generated by electro-oxidative reactions within the at least one electrochemical cell is supplied to the physical retention unit to contact and degrade the at least one contaminant retained and captured within the retention material.

In some embodiments, the fluid stream may comprise greywater, wastewater, or water. In some embodiments, the at least one contaminant may be an organic compound. In some embodiments, the at least one contaminant may comprise a microplastic.

In some embodiments, the retention material may comprise a chemically inactive material. In some embodiments, the retention material may be selected from the group consisting of a mesh material, a sand material, and a bead material.

In some embodiments, the at least one first electrode may be connected to a positive pole of a voltage source and the at least one second electrode may be connected to a negative pole of the voltage source during the electro-oxidative reactions. The at least one first electrode may be selected from the group consisting of lead (IV) oxide (PbO2), tin (IV oxide (SnO2), platinum (Pt), ruthenium (IV) oxide (RuO2), iridium (IV) oxide (IrO2), and Boron-doped diamond (BDD). The at least one second electrode may be stainless steel.

In some embodiments, the electrochemical cell may be configured for laminar fluid flow fields substantially perpendicular to the opposing first and second electrode (i.e., where the fluid flowing through one of the first or second electrodes (e.g., flowing through a perforated cathode) may be substantially perpendicular to the opposing other electrode (e.g., towards the anode operatively adjacent the perforated cathode)).

In some embodiments, the at least one second electrode may be perforated.

According to embodiments, apparatus and methods for removal and degradation of at least one contaminant from a fluid stream are provided. In some embodiments, the method comprises providing a physical retention unit containing a retention material, providing at least one electrochemical cell having a first and a second electrode operably connected to the physical retention unit, introducing at least a portion of the fluid stream as an input fluid stream to the physical retention unit and allowing the at least one contaminant to be received and captured by the retention material, operating the electrochemical cell to generate at least one oxidizing agent, supplying the at least one oxidizing agent to the physical retention unit to degrade the at least one contaminant, and discharging at least a portion of the fluid stream from the physical retention unit as an output fluid stream.

In some embodiments, the method may further comprise generating a turbulent fluid flow path for the input fluid stream passing through the physical retention unit, wherein the turbulent fluid flow path may form a vortex.

In some embodiments, at least a portion of the output fluid stream may be recirculated back to the electrochemical cell.

In some embodiments, the method may further comprise generating a laminar fluid flow path for the recirculated output fluid stream passing through the electrochemical cell, wherein the laminar fluid flow path may be substantially perpendicular to the opposite or opposing at least one first and second electrodes.

In some embodiments, the oxidizing agents generated by the electrochemical cell may be supplied to the physical retention unit directly or indirectly.

In some embodiments, the input fluid stream may be introduced to the physical retention unit continuously.

### BRIEF DESCRIPTION OF THE DRAWINGS

FIG. 1 shows a generalized process flow diagram depicting the present apparatus, according to embodiments;

FIG. 2 shows a generalized process flow diagram depicting an alternative embodiment of the present apparatus, according to embodiments;

FIG. 3 shows a generalized process flow diagram depicting a further alternative embodiment of the present apparatus, according to embodiments;

FIG. 4 provides a graphical representation of the resulting removal and degradation of at least one contaminant by the present apparatus, according to embodiments;

FIG. 5A shows an image depicting contaminants captured and retained within a physical retention unit (PRU) of the present apparatus, according to embodiments;

FIG. 5B shows an image depicting the physical retention unit (PRU) of FIG. 5A, with the contaminants having been removed and degraded, according to embodiments;

FIG. 6 shows generalized process flow diagram depicting an alternative embodiment of the present apparatus, according to embodiments;

FIG. 7 shows a schematic diagram of an alternative embodiment of the physical retention unit (PRU) of the present apparatus, the PRU configured to create a fluid flow vortex therethrough, according to embodiments;

FIG. 8 shows example computer fluid dynamic (CFD) images representing the turbulent fluid flow path caused by the fluid flow vortex of FIG. 7 in a perspective side view (FIG. 8A), in a cross-sectional side view (FIG. 8B), and in graphical representation of the cross-sectional side view shown in FIG. 8B, the view showing arrows summarizing fluid flow (FIG. 8C), according to embodiments;

FIG. 9A shows a perspective cross-sectional view of an alternative embodiment of the electrochemical cell of the present apparatus, the electrochemical cell configured to create a fluid flow path substantially perpendicular to the electrode(s) through the electrochemical cell; and

FIG. 9B shows a cross-sectional side view of the alternative embodiment of the electrochemical cell of the present apparatus shown in FIG. 9A.

### DETAILED DESCRIPTION OF THE PREFERRED EMBODIMENTS

According to embodiments, apparatus and methods of use are provided for enhanced removal and degradation of at least one contaminant from a fluid stream, including organic compounds from water, greywater, wastewater, and the like. In some embodiments, the presently improved apparatus may be configured to facilitate enhanced oxidation of a bulk solution, providing rapid oxidation of the at least one contaminant. In some embodiments, the present apparatus may be regenerative, operating as a self-cleaning unit capable of oxidizing compounds of all size, shape, and type.

More specifically, according to some embodiments, an apparatus and methods of use are provided for the targeted removal and degradation of at least one contaminant from a fluid stream, the system comprising at least one physical retention unit having at least one inlet for receiving at least a portion of the fluid stream as an input fluid stream and at least one outlet for discharging at least a portion of the fluid stream as an output fluid stream, and containing a retention material configured to receive and capture the at least one contaminant from the input fluid stream, and at least one electrochemical cell having a first and a second electrode, operatively connected to the physical retention unit, wherein at least one oxidizing agent(s) generated by electro-oxidative reactions within the at least one electrochemical cell are supplied to the physical retention unit to contact and degrade the at least one contaminants retained and captured within the retention material.

According to other embodiments, apparatus and methods of use are provided for removing and degrading at least one contaminant from a fluid stream, the method comprising providing a physical retention unit containing a retention material, providing at least one electrochemical cell having a first and a second electrode operably connected to the physical retention unit, introducing at least a part of the fluid stream as an input fluid stream to the physical retention unit and allowing the at least one contaminant to be received and captured by the retention material, operating the electrochemical cell to generate at least one oxidizing agent, supplying the at least one oxidizing agent to the physical retention unit to degrade the at least one contaminant, and discharging at least a part of the fluid stream from the physical retention unit as an output fluid stream.

Certain terminology is used in the present description and is intended to be interpreted according to the definitions provided below.

Herein, the terms ‘contaminant(s)’ and/or ‘pollutant(s)’ are used interchangeably to mean any molecule, cell, or particulate to be removed from a fluid stream including, without limitation, suspended and/or solid compounds including organic compounds such as microplastics, microfibers, pesticides, dyes, pharmaceuticals, and/or biofilms. In some embodiments, at least a portion of the fluid stream may comprise greywater and/or wastewater. In other embodiments, at least a portion of the fluid stream may comprise water for water purification.

Herein, the terms ‘greywater’ or ‘wastewater’ are used interchangeably to mean urban and domestic wastewater commonly generated in households, office or industrial buildings, ships, aircraft, and vehicles from sinks, showers, baths, and washing machines or dishwashers (i.e., all urban and domestic fluid streams excluding the wastewater from toilets, or that contain fecal matter).

Herein, the terms ‘microplastic(s)’, ‘MPs’, or ‘microbeads’ are used to mean solid form pollutants found in various fluids in the environment, including wastewater, having various dimensions, structures, densities, colours, and types of polymers. Microplastics can be generally categorized morphologically as fiber, sphere, foam, sheet, fragment, and film, or combinations of the same, with microfibers being most commonly detected in the environment. Microplastics may also be colloidally suspended within a fluid as dispersed insoluble particles or suspended as larger aggregates.

Herein, ‘microfibers’ is used to mean microplastic fibers having average concentrations and sizes in water ranging from 0.02-25.8 fibers/L and 0.09-27.06 mm, respectively. Garment industries are a primary source of microfibers in the environment, where microfibers are produced during various stages of garment washing and released with wastewater from such processes as washing effluent. As such, fiber-shaped microplastics are increasingly found in the environment from the mounting discharge of the clothing industry, both industrial and residential, and through further fragmentation that can occur through the process of weathering.

Herein, ‘oxidizing radicals’, ‘oxidative species’, ‘oxidative agents’, and ‘oxidative products’ means any species or substance operative as an oxidizer, i.e., having the ability to oxidize another substance.

Each term used and defined herein is for explanatory purposes only and in no way is intended to limit the scope of the technology.

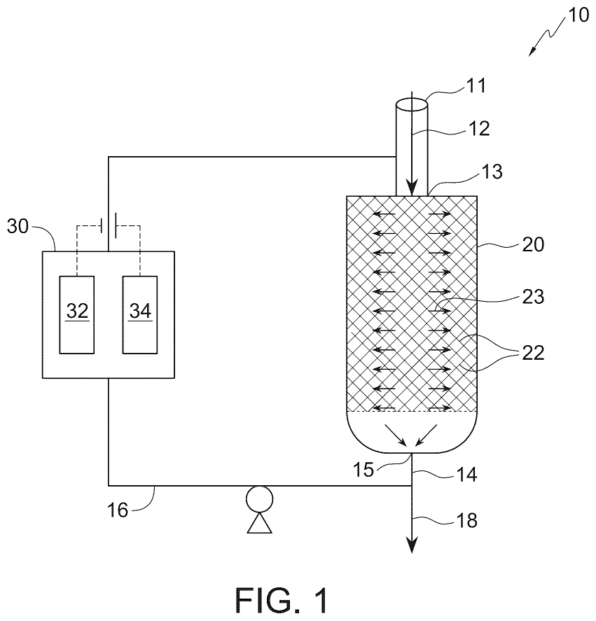

The present apparatus and methods of use will now be described having regard to FIGS. 1-9.

According to embodiments, having regard to FIG. 1, the present apparatus 10 and methods of use for the treatment of wastewater may comprise at least one physical retention unit 20 operably connected to at least one electrochemical cell 30. As will be described, at least a portion of an input fluid stream, or ‘influent’ 12, containing at least one organic contaminant may be introduced to the physical retention unit 20 whereby the organic contaminants are captured by a retention material 22. While retained, the contaminants are contacted with and degraded by strong oxidizing radicals from at least one electrochemical cell 30. Although the influent fluid stream 12 may be described herein as containing at least one contaminant, it should be understood that the present apparatus 10 may also be operative in a fluid purification application where the influent fluid stream 12 may be purified of contaminants and/or other persistent organics, such as perfluoroalkyl substances (PFAs), to provide a more sterilized or distilled fluid stream.

Without being limited by theory, and contrary to known systems that aim to prevent immobilization of pollutants in filters, the present arresting of contaminants within the physical retention unit 20 enables a longer, more targeted oxidation period in a small, simple system, providing effective and more efficient degradation of the contaminants with lower concentrations of oxidants. Counterintuitively, immobilization of the contaminants within the physical retention unit 20 of the present apparatus 10 allows for continuous treatment of fluids over a longer reaction time, eliminating the need for a storage tank for accumulated wastewater.

By way of example, in some applications, the present apparatus 10 may comprise a compact stand-alone fluid treatment system, referred to as a VEOX™ unit, operative as a plug-and-play regenerative, self-cleaning, microplastics mitigation system. In some applications, the system may be designed to connect to urban or domestic wastewater generating equipment, such as a washing machine, and serving to destroy organic compounds discharged from the washing machine regardless of the size, shape, charge, and/or type of compounds. In other applications, the present apparatus 10 may readily integrate into existing water lines entering a water feed system for animals (e.g., a bird pen, or poultry farm), the VEOX™ unit serving to continuously purify, clean, and/or disinfect fluid streams from a variety of bacteria including E. coli and Salmonella.

As will also be described, at least a portion of the treated output fluid stream, or ‘effluent’ 14, free of contaminants (and oxidizing agents) may pass from the physical retention unit 20, whereby at least a first portion of the output stream 16 may be recycled and recirculated back through the at least one electrochemical cell 30, and at least a second portion of the output stream 18 is safe for further treatment, storage, or discard. Advantageously, recirculation and reuse of at least a portion of the outstream 16 enables a regenerative oxidative process, providing a self-cleaning system without the use of chemicals or the generation of added waste.

As above, having further regard to FIG. 1, the present apparatus 10 may comprise at least one means for filtering and retaining at least one contaminant from a fluid stream, said means referred to herein as a physical retention unit 20 (the “PRU”), having at least one inlet 13 end for receiving an input fluid stream 12 into the PRU 20 and at least one outlet 15 end for discharging an output fluid stream 14 from the PRU 20.

In some embodiments, the PRU 20 may comprise a vessel for receiving and allowing the passage of the input fluid stream 12 therethrough. In some embodiments, the PRU 20 may comprise a substantially cylindrical vessel configured substantially vertically, however any size, shape, or configuration of PRU 20 is contemplated.

In some embodiments, at least a portion of the inlet fluid stream 12 containing contaminants may be introduced to the PRU via inlet 13. As above, the fluid stream 12 may comprise wastewater containing contaminants, or water to be purified. The inlet fluid stream 12 may be supplied to the PRU 20 through at least one inlet header means, such as a fluid supply pipe 11, in fluid communication with the PRU 20. Fluid supply pipe 11 may be positioned at or near the top of the PRU 20 and may be centrally disposed to evenly disperse the input fluid stream 12 about the body of the PRU 20. Although one fluid supply pipe 11 is shown, it is contemplated that any number of fluid supply pipes, nozzles, valves, pumps, manifolds, or the like may be used, as may be needed or desired.

In some embodiments, the PRU 20 may be designed to house and support means for filtering and retaining at least one contaminant from the input fluid stream 12, the means serving to receive and capture the contaminants from the fluid stream as it passes through the PRU 20 (e.g., arrows 23, FIG. 1). That is, as the input fluid stream 12 is introduced to the PRU 20 via inlet 13, the input stream 12 will be directed to flow through retention material 22 such that contaminants in the fluid stream 12 contact retention material 22 and are retained therein, filtering them from the bulk solution (i.e., that part of the solution where the solution's molecules may only be influenced by other solution molecules, and not by any solid or gas molecules).

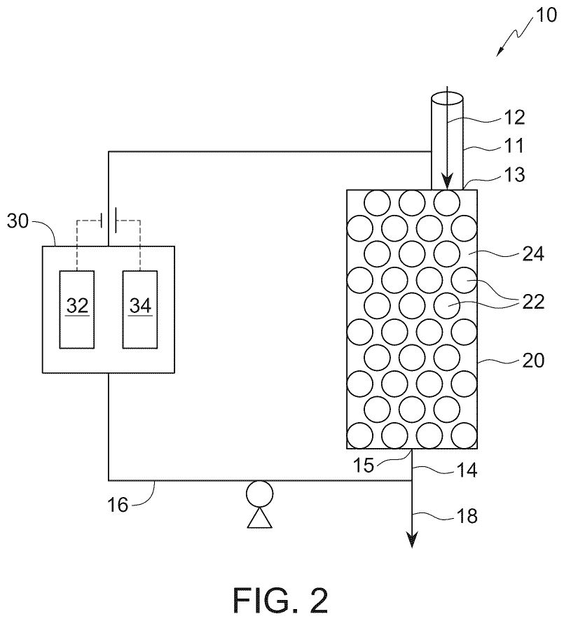

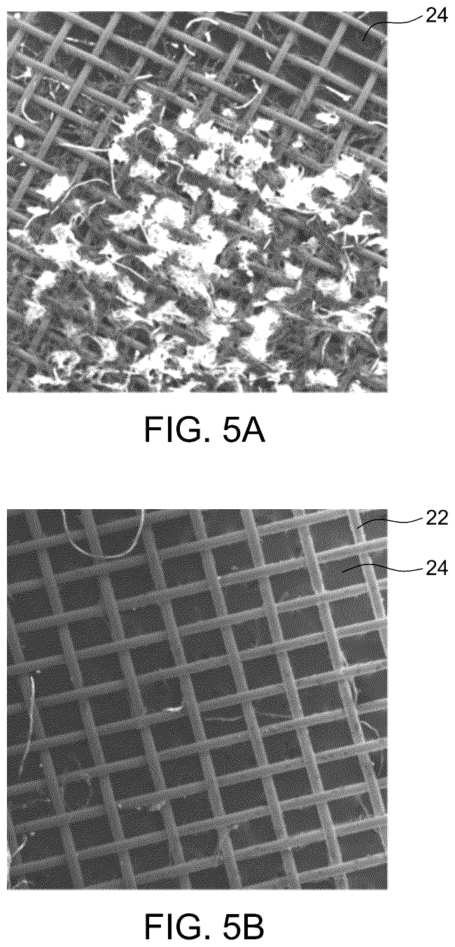

According to embodiments, the means for filtering at least one contaminant may comprise any chemically inactive or inert filter substance. In some embodiments, having regard to FIG. 1, retention material 22 may comprise a layered mesh material extending substantially horizontally across the entire cross-section of PRU 20 and forming a plurality of apertures or slots 24 (for e.g., see FIGS. 2, 5A, and 5B).

For example, in some embodiments, retention material 22 may comprise a stainless steel woven/weaved wire mesh (e.g., 40-100 mesh; 400-60 μm; SS304 industry standard woven wire mesh; or other such commercially available mesh having a wire thickness of approximately 0.1 mm, a width of approximately 1 m, and a length of approximately 30 m, although such measurements may or may not be as used in PRU 20). Apertures 24 may vary in size and dimension, so as to immobilize filtered contaminants, while still allowing fluid flow through the PRU 20.

In other embodiments, having regard to FIG. 2, retention material 22 may comprise a packet bed, such as solid-glass beads (e.g., borosilicate, diam. 6 mm, 3 mm, 1 mm; Sigma Aldrich Z143952), standard sand (e.g., particle size approximately 0.2-0.8 mm; Sigma Aldrich CAS #14808-60-7; SiO₂; Molar Mass 60.08 g/mol), and/or stainless steel beads (e.g., 0.9-2.0 mm blend, having a density of 7.9 g/c).

Although mesh, sand, and bead filter materials are described herein, it should be appreciated that any suitable filter material known in the art to physically filter and retain contaminants from the inlet fluid stream 12 is contemplated. It is desirable that such filter material can serve to capture the at least one contaminant, increasing its retention and reaction time within the PRU 20, such that the at least one contaminant may be continuously and uniformly contacted by reactive agents generated by the at least one electrochemical cell 30 (i.e., such that the filter material increase the time the at least one contaminant is exposed to oxidizing agents). It is desirable that such filter material provide a physical separation of the at least one contaminant without using any charge or bond affinity (i.e., material 22 does not require a charge to retain/attract contaminants), so as to retain the contaminants within the PRU 20 until they are fully oxidized. In this manner, advantageously, the filter material is simultaneously oxidized (and cleaned) by the continuous interactions between the PRU 20 and the oxidants generated in the electrochemical cell 30, providing a longer lifetime of the apparatus 10 (due to catalysts being supported on resistant filter materials to prevent fault or fouling).

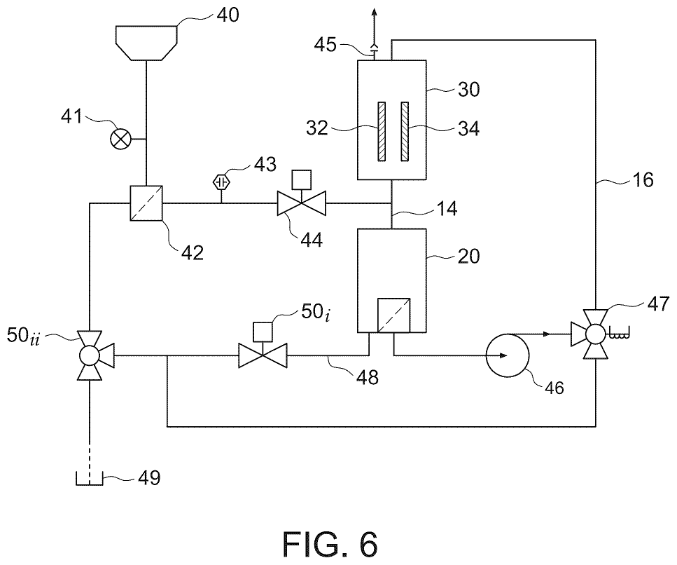

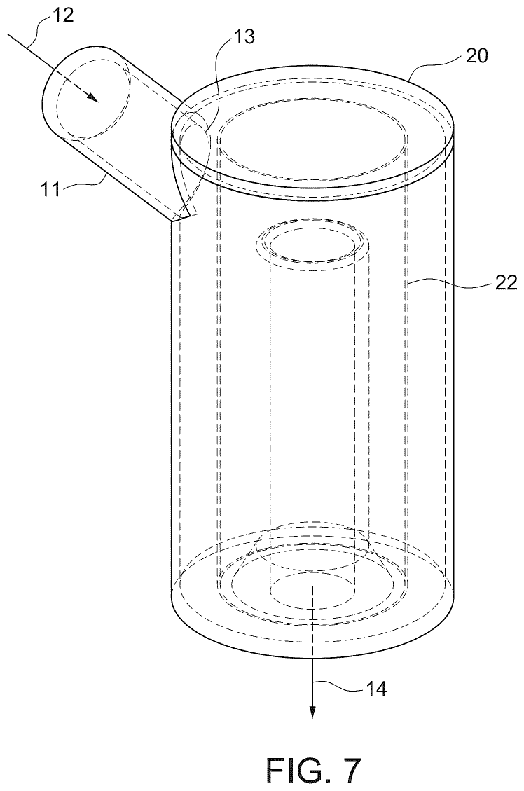

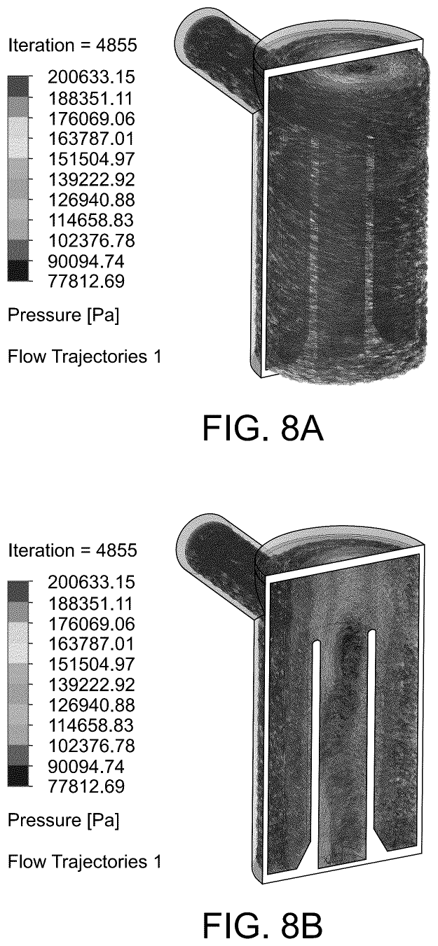

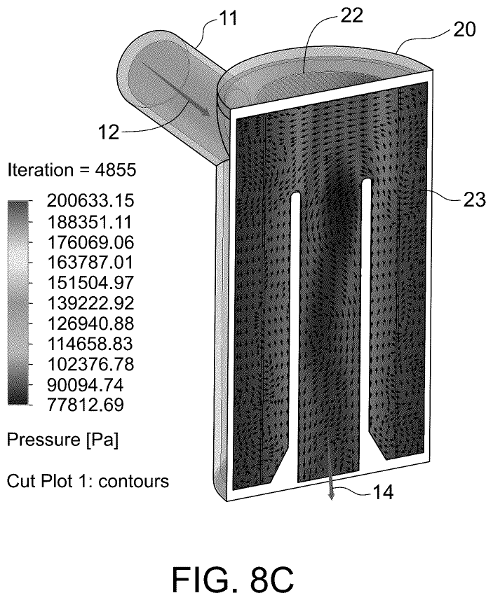

In some embodiments, in addition to housing and supporting means for filtering at least one contaminant from the input fluid stream 12, the PRU 20 may also be further configured to generate or cause a turbulent fluid flow path (i.e., where the fluid is caused to undergo irregular fluctuations, mixing, and/or changes in fluid flow speed both in magnitude and direction) through the unit 20 (see FIG. 6). For example, having regard to FIG. 7, the PRU 20 may be configured to house and support retention means 22 positioned to receive input fluid stream 12 in a vortex flow pattern, such as at least one substantially cylindrical retention means 22, for filtering the at least one contaminant. In such embodiments, the PRU 20 itself may be designed to generate a vortical fluid flow pattern (see FIGS. 8A-8C) or, in addition, the PRU 20 may be operatively connected to at least one turbulator (e.g., vortex turbulator, not shown), the turbulator operative to generate a turbulent fluid flow path of the input fluid stream 12, such flow path passing substantially around and through filter means 22 (e.g., in a whirling, helical or circular flow path). Although a cylindrical retention means 22 is described, it should be understood that any appropriately configured retention means for vortex flow filtration is contemplated.

Without being limited to theory, increasing turbulent flow of input stream 12 can increase the dwell time and reaction time on the surface of the filter means 22, enhancing mixing due to the vorticity. Additionally, a turbulent fluid flow path may serve to loosen contaminants from filter means 22 (e.g., electrically unreactive or unoxidized), allowing improved reaction rates and reducing clogging.

For example, in some embodiments, a turbulent fluid flow path may be generated causing the input stream 12 to pass substantially downwardly around the outside of filter means 22, and then upwardly against the inside of filter means 22 (as represented graphically in FIGS. 8A-8C). In some embodiments, where desired, one or more fluid flow diverters may be provided, directing fluid 12 entering physical retention unit 20 and further enhancing filtration and retention of at least one contaminant within the fluids by potentially creating a centrifugal force urging larger, denser, and/or more massive particles to collect along outer portions of the vortical flow path.

As above, according to embodiments, the present apparatus 10 comprises at least one electrochemical cell 30. The electrochemical cell 30 may be operatively connected to and in fluid communication with the PRU 20, such that oxidative species generated by the electro-chemical reaction within the cell 30 can be supplied to the PRU 20 and such that at least a portion of the clean (e.g., ion- and contaminant-free) output fluid stream 14 may be recirculated back to the cell 30. In this manner, the present electrochemical cell 30 may continuously supply oxidative species to the PRU 20 for constant cleaning/degradation of contaminants retained therein. Advantageously, the presently described apparatus 10 and methods of use aim to provide a self-sufficient regenerative fluid treatment system.

Having regard to FIG. 1, the cell 30 may comprise at least two electrodes, such as a cathode 32 and an anode 34, operably connected to a voltage source (e.g., DC power supply, not shown) to produce at least one reactive product, such as a reactive oxidizing agent or species, via at least one electro-chemical reaction. In some embodiments, the cathode 32 may be comprised of any appropriate materials known in the art such as Ni, stainless steel, Ti, NiCoLaOx, etc. In some embodiments, the at least one anode 34 may be lead (IV) oxide (PbO₂), tin (IV oxide (SnO₂), platinum (Pt), ruthenium (IV) oxide (RuO₂), iridium (IV) oxide (IrO₂), Boron-doped diamond (BDD), etc.

In some embodiments, the electrochemical cell 30 is active, having the cathode 32 connected to a negative pole of a voltage source and the anode 34 connected to a positive pole of a voltage source (e.g., the voltage source comprising a DC power supply, not shown). In some embodiments, the at least one reactive oxidizing agent may be generated by the electrochemical cell 30 and may be supplied to the PRU 20 so as to contact the at least one contaminant to be treated therein.

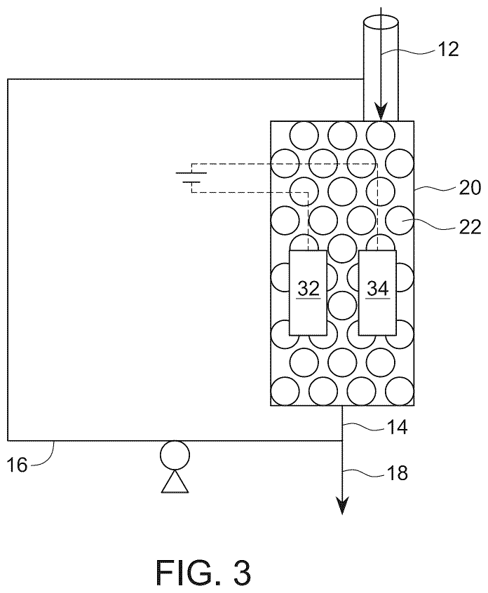

In some embodiments, the electrochemical cell 30 may be configured for direct electro-oxidation of contaminants within the fluid stream 12, while in others the electrochemical cell 30 may be configured for indirect electro-oxidation of the contaminants. For example, the at least one reactive oxidizing agent may be introduced alone or in combination with the input fluid stream 12 (i.e., in embodiments where the electrochemical cell 30 may be positioned outside of the PRU 20; FIGS. 1 and 2), or the at least one reactive oxidizing agent may be generated within the PRU 20 (i.e., in embodiments where the electrochemical cell 30 may be positioned within the PRU 20; FIG. 3). That is, in some embodiments, PRU 20 may be configured to house and support at least one electrochemical cell 30 therein, wherein the at least one electrodes 32,34 may further serve as and/or enhance filtration by retention material.

In some embodiments, the present apparatus 10 may further comprise means for mitigating the effects of boundary layer flow stagnation within the electrochemical cell 30. Without being limited by theory, given that mass transport can be an important factor impacting the efficacy of electro-oxidation reactions, the generation of a turbulent fluid flow path can increase system efficiencies. For example, it can be desirable to mitigate the effects of boundary layer flow stagnation that might occur on electrode surfaces in electrochemical applications. Boundary layer flow stagnation, which typically occurs upon electrode surfaces when fluid flow is parallel to the electrode, can greatly impede reaction rates and reduce system effectiveness. Such conditions also derate the occurrences of electrochemical reactions where the reactant generation or catalyzation depends on the proximity of electrode electrochemical exchange.

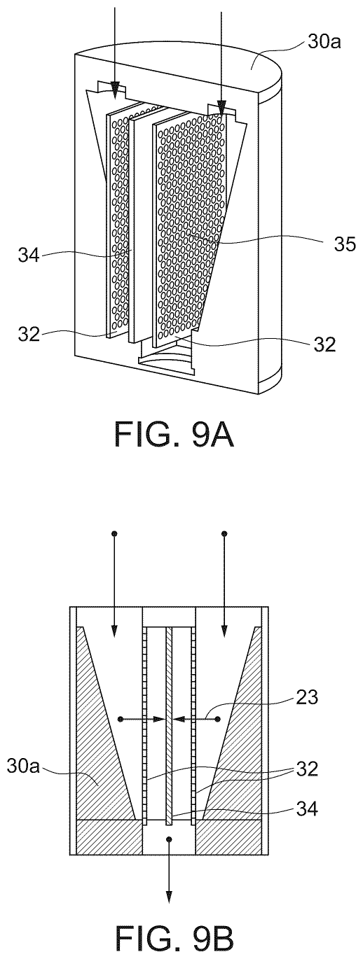

According to embodiments, having regard to FIGS. 9A and 9B, the present apparatus 10 may comprise an alternative electrochemical cell 30a designed to generate or cause a fluid flow path through the electrochemical cell 30a that is substantially perpendicular to the electrode(s). For example, the electrochemical cell 30a may configured to provide a fluid flow conditioning device geometrically shaped to form laminarized fluid flow fields through the electrochemical cell 30a that are substantially perpendicular to the electrode(s).

More specifically, in some embodiments, the electrochemical cell 30a may comprise at least two electrodes, such as a cathode 32 and an anode 34, operably connected to a voltage source (e.g., a DC power supply, not shown) to produce at least one reactive product, such as a reactive oxidizing agent or species, via at least one electro-chemical reaction (as described above). In some embodiments, the at least one cathode 32 may comprise a plurality of perforations 35 operative to direct fluids flowing through the electrochemical cell 30a (e.g., at least a portion of discharge fluids 16 from the PRU 20) to the opposing electrode(s) reaction surfaces. In some embodiments, as the input fluid stream is introduced to the electrochemical cell 30a, the input stream will be directed to flow through perforations 35 of perforated cathode 32 and towards the surface of opposing or operably adjacent anode 34 before exiting the cell 30a (and subsequently entering PRU with input fluid stream 12). Such fluid flow may pass through laminar fluid flow fields via, for example, a pressure or flow volume equalization device.

Without being limited by theory, although perforated cathode(s) 32 are described, any means for shaping flow path in the electrochemical cell 30a such that the boundary layer flow stagnation occurring in parallel flow conditions are mitigated by near electrode(s) surface vortex generation are contemplated. It is also contemplated that such configurations may further permit the adjustment of localized flow field interactions and mixing enhancements by the use of variable shaped patterns and structures as the fluids flow through electrode(s), enabling interacting vortices generation and promoting accelerated reactions.

It is contemplated that any advanced oxidation process (AOP) suitable to remove at least one organic contaminant from a fluid stream by oxidation through reactions with at least one oxidizing agent (e.g., hydroxyl radicals) generated by electro-oxidative reactions are contemplated. Without limitation, it is contemplated that any APO chemical procedure may be used including purely electrochemical (mostly anodic), electro-Fenton process (addition of Fe²⁺ to H₂O₂ producing cathode), and/or photoelectrochemical process (using an auxiliary ultraviolet (UV) source to convert the H₂O₂ to hydroxy radicals (·OH), etc.).

According to embodiments, without limitation, it is contemplated that any other componentry including additional or layered cathodes/anodes, retention materials, pumps, valves, degas units (for contaminants that oxidize and/or degrade into gases), agitators (to aid in distributing the oxidants in the retention material), catalysts/catalyst compositions, as required, may be incorporated into the present apparatus 10, such system being controlled and monitored automatically.

For example, having regard to FIG. 6, the present apparatus 10 may further comprise one or more intake units 40 for storing the at least one inlet fluid 12 (either prior to introduction to, or following discharge from the PRU 20). Such intake unit 40 may comprise one or more intake pressure sensors and/or fluid control valves 41 for controlling fluid flow. In some embodiments, the present apparatus 10 may further comprise at least one particle separator 42 and/or at least one turbidity sensor 43. As would be appreciated, the present apparatus 10 may further comprise at least fluid intake valve 44, overpressure burst disk 45, at least one recirculation pump 46 and corresponding recirculation fluid control valve 46. In some embodiments, the present apparatus 10 may further comprise at least one drainage fluid line 48 in fluid communication with at least one drain 49, for disposal of at least a portion of the discharge fluids 16 exiting the PRU 20. Drainage fluid line 48 may comprise at least one fluid control valve(s) 50i, 50ii, . . . 50n.

The present apparatus and methods of use for removal and degradation of at least one contaminant from a fluid stream will now be illustrated in more detail by way of the following Example(s).

### Example

Herein, the present methods comprise providing at least one apparatus as described according to embodiments above.

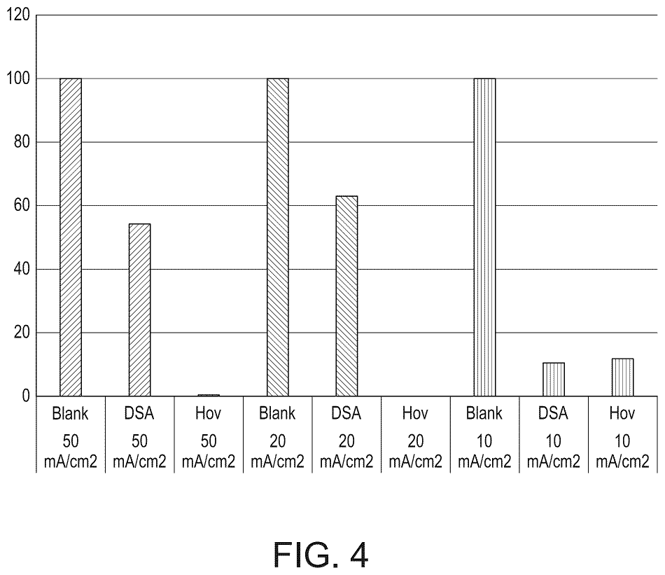

For example, at least one PRU 20 containing a retention material 22 operably connected to at least one electrochemical cell 30 was used. The least one electrochemical cell 30 comprised a cathode 32 and an anode 34, both approximately 100 mm×50 mm×3 mm in size, and distanced approximately 5 mm apart. Cathode 32 comprised a stainless steel cathode 32 (grade 304). Two anodes 34 were used, anodes 34 comprised of BDD (DIACHEM BDD, polycrystalline, 5 μm thick, 1000-4000 ppm boron doping on monocrystalline niobium plate) and RuOx (RuO₂ coating titanium) double-sided. Current density of the electrochemical cell 30 was approximately 25-200 mA/cm2 (e.g., 10 mA/cm²-50 mA/cm²; FIG. 4) with a flow rate of approximately 25 L/min, a recirculation rate of approximately 4 L/min and a recirculation volume of approximately 1 L.

At least a portion of the fluid input stream 12 was introduced to the inlet end 13 of the PRU 20 and contacted with the retention material 22. As the fluid stream 12 passed through the retention material 22, at least a portion of the contaminants within the fluid stream were received and captured by the retention material 22 (see FIG. 5A). The electrochemical cell 30 was activated to generate at least one reactive oxidizing agent by electro-oxidation reactions for simultaneous introduction to the inlet end 13 of the PRU 20. Contact between the at least one reactive oxidizing agent and the at least one contaminant immobilized within the retention material 22 caused the removal and degradation of the at least contaminant (see FIG. 5B, which shows the same retention material 22 shown in FIG. 5A two hours after treatment with a BDD anode 34 and 50 mA/cm2). The oxidizing agent- and contaminant-free fluid stream passing through the retention material 22 was discharged from the PRU 20 via the outlet end 15 to form the output fluid stream 16.

At least a portion of the output fluid stream 16 was recirculated back to the electrochemical cell 30 for recycle and reuse by the present apparatus 10. Because the immobilized contaminants within the PRU 20 are completely mineralized (e.g., into CO₂), the retention material 22 is primed to continuously receive further contaminants from the input fluid stream 12 and further reactive oxidizing agents from the electrochemical cell 30.

Having regard to FIG. 4, the present apparatus and methods of use destroyed up to 95% of the total organic carbon and up to 99% of the plastic microfibers present within the input fluid stream 12 (e.g., the mass removal of microfibers shows a significant effect on the current density reaching undetectable values of total organic carbon (TOC) after 2 hours of treatment using BDD at 20 and 50 mA/cm2). It should be appreciated that the present apparatus 10 is approximately 10 times more efficient at degrading the at least one contaminant than known systems (e.g., such known systems combining a charged physical separation membrane with photo- or electro-chemistry, such systems however necessitating that the filter membrane have an active role in separating molecules by size and affinities and having no interaction between the charged filter membrane and the oxidizing agents).

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and the described portions thereof.

We claim:

1) An apparatus for removal and degradation of at least one contaminant from a fluid stream, the apparatus comprising:
at least one physical retention unit, the unit having
at least one inlet for receiving at least a portion of the fluid stream as an input fluid stream and at least one outlet for discharging at least a portion of the fluid stream as an output fluid stream, and
containing a retention material, the material configured to receive and capture the at least one contaminant from the input fluid stream, and
at least one electrochemical cell, the cell having a first and a second electrode, operatively connected to the physical retention unit,
wherein at least one oxidizing agent generated by electro-oxidative reactions within the at least one electrochemical cell is supplied to the physical retention unit to contact and degrade the at least one contaminant retained and captured within the retention material.

2) The apparatus of claim 1, wherein the fluid stream comprises greywater, wastewater, or water.

3) The apparatus of claim 1, wherein the retention material comprises a chemically inactive material.

4) The apparatus of claim 3, wherein the retention material is selected from the group consisting of a mesh material, a sand material, and a bead material.

5) The apparatus of claim 4, wherein when mesh material, the retention material is substantially cylindrical.

6) The apparatus of claim 1, wherein the at least one first electrode is connected to a positive pole of a voltage source and the at least one second electrode is connected to a negative pole of the voltage source during the electro-oxidative reactions.

7) The apparatus of claim 6, wherein the at least one first electrode is selected from the group consisting of lead (IV) oxide (PbO2), tin (IV oxide (SnO2), platinum (Pt), ruthenium (IV) oxide (RuO2), iridium (IV) oxide (IrO2), and Boron-doped diamond (BDD) and the at least one second electrode is stainless steel.

8) The apparatus of claim 1, wherein the electrochemical cell is configured for laminar fluid flow fields substantially perpendicular to the first and second electrode.

9) The apparatus of claim 8, wherein the at least one second electrode is perforated.

10) The apparatus of claim 1, wherein the physical retention unit is configured to house and contain the at least one electrochemical cell.

11) The apparatus of claim 1, wherein the at least one contaminant comprises an organic compound.

12) The apparatus of claim 11, wherein the organic compound may comprise a microplastic.

13) A method of removing and degrading at least one contaminant from a fluid stream, the method comprising:
providing a physical retention unit containing a retention material,
providing at least one electrochemical cell having a first and a second electrode operably connected to the physical retention unit,
introducing at least a portion of the fluid stream as an input fluid stream to the physical retention unit and allowing the at least one contaminant to be received and captured by the retention material,
operating the electrochemical cell to generate at least one oxidizing agent,
supplying the at least one oxidizing agent to physical retention unit to degrade the at least one contaminant, and
discharging at least a portion of the fluid stream from the physical retention unit as an output fluid stream.

14) The method of claim 13, wherein the method further comprises generating a turbulent fluid flow path for the input fluid stream passing through the physical retention unit.

15) The method of claim 14, wherein the turbulent fluid flow path forms a vortex.

16) The method of claim 13, wherein at least a portion of the output fluid stream is recirculated back to the electrochemical cell.

17) The method of claim 16, wherein the method further comprises generating a laminar fluid flow path for the recirculated output fluid stream passing through the electrochemical cell.

18) The method of claim 17, wherein the laminar fluid flow path is substantially perpendicular to the at least one first and second electrodes.

19) The method of claim 13, wherein the oxidizing agents generated by the electrochemical cell are directly or indirectly supplied to the physical retention unit.

20) The method of claim 13, wherein the input fluid stream is introduced to the physical retention unit continuously.
